(19) United States
(12) Patent Application Publication
(10) Pub. No.: US 2010/0185323 A1
(43) Pub. Date: Jul. 22, 2010

(54) DRINK PROTECTION SYSTEMS

(76) Inventors: Timothy Nicolas Moor, Nun Monkton (GB); Clea Marshall, Blockhouse Bay (NZ); David Shieff, St. Hellers (NZ)

Correspondence Address: DOBRUSIN & THENNISCH PC, 29 W LAWRENCE ST, SUITE 210, PONTIAC, MI, 48342, US

(21) Appl. No.: 12/594,466

(22) PCT Filed: Apr. 7, 2008
(86) PCT No.: PCT/EP2008/002756

§ 371 Date: Mar. 25, 2010

(30) Foreign Application Priority Data
Apr. 5, 2007 (GB) 0706754.9
Oct. 8, 2007 (GB) 0719598.5
Feb. 8, 2008 (GB) 0802389.7

(51) Int. Cl. G06F 17/00; B01D 35/02; B65D 85/72; B65D 23/00; B65D 51/00

(52) U.S. Cl. 700/243; 210/467; 426/398; 215/386; 215/228; 700/242

(57) ABSTRACT

A device is provided for insertion into a drinking vessel to prevent accidental or deliberate contamination of the contents of the vessel, the device may be inserted on the drink production line or at the point of sale of the drink, in either embodiment the vessel is provided to the consumer with the device in place.

The present invention relates to means for improving the integrity and/or protecting the contents of beverages. In particular the invention relates to systems which prevent or deter contaminants such as insects and illicit substances from entering or being placed in beverages such as soft drinks including water, still or carbonated, alcoholic drinks such as wines and beers and alcoholic ready to drink mixes/beverages. In a particularly useful embodiment this invention is directed at the people who drink directly from the beverage container as opposed to decanting contents to a secondary drinking vessel such as a cup or glass. In certain instances the device can make it difficult to decant thus reducing the likelihood of contamination in a secondary vessel.

Beverages are frequently supplied in bottles or cans provided with a cap such as a screw threaded cap, a ring pull or a crown cap which are usually provided with or act as a tamper evident seal. From the moment the tamper evident seal is broken on a bottle, the ring pull is opened on a can, or a crown cap is removed, there is a risk of another contaminating substance being inserted or accidentally entering the drink without the consumer's knowledge. Examples of contaminants include deliberately introduced materials for spiking drinks to adversely affect the consumer such as drugs; accidental occurrences can be insects such as wasps, bees and flies entering into a drink to which they are attracted.

Systems have been proposed which can be inserted into the opening of a can or bottle once it has been opened to safeguard against deliberate or accidental contamination of the contents. However all previous devices put the responsibility for providing the safeguard with the consumer of the beverage, in that they are expected to insert the ‘drink safe’ component themselves every time they have a new drink. These systems make no provision for human error, hygiene issues, storage of devices or a person's mentality after a few alcoholic drinks have been consumed.

Once one alcoholic beverage has been consumed, it is very easy to relax and forget the concerns of safe drinking with subsequent beverages. Furthermore, within a bustling environment such as a darkened room with flashing lights, loud dance music and many distractions typical of most night club settings, ‘fashionable’ bars etc. it is not always possible to remember to insert a drink safe device or to insert one in the correct way.

As most people are aware, it is socially accepted to buy your fellow drinking companion(s) a drink, known as rounds. It is possible, that the intended victim of drink contamination such as a ‘Date Rape’ attempt may not have been given the drink directly from the barman who opened it in front of them whilst they were watching. In these circumstances an illicit substance could have been introduced into the beverage before the ultimate consumer is able to insert a drink safe device.

Furthermore, it will not always be appropriate for drink safe devices to only work in conjunction with a straw such as those described in GB patent publications GB2415691 and GB2409201 since drinking directly from the bottle is often preferred.

The device of GB2415691 comprises a central core provided with a top flange and several circumferential flanges which secure the device in the neck of a bottle. The top flange is provided with a hole for a drinking straw which is provided with an internal flange to make/removal of the straw difficult. This device suffers from three main drawbacks. Firstly in order to provide protection it must be inserted into the bottle neck and a straw inserted into the hole provided. Secondly it can only be used for drinking though a straw and thirdly the circumferential flanges provide barriers for the passage of air into the container to replace consumed liquid or the passage of liquid for consumption. Effective use therefore requires the consumer to observe if anything has been placed in the cavity. The present invention provides an improved protection device and further provides means whereby the protection device may be inserted prior to delivery of the beverage to the customer.

There are also test systems which show or indicate to a potential consumer that an illicit substance has been mixed with a beverage. Sensible though these systems are, the likelihood of drinkers testing their drink and waiting up to 30 seconds to see results multiple times throughout the course of the drinking session/period are very remote.

Mouthpiece protection versions also exist such as those described in GB2416349 as do complex external versions which attach to the outside of the bottle such as those described in GB2417951.

In one embodiment this invention provides a beverage protection device that can be provided to the vessel, such as a can or bottle, during the filling and capping process and which remains in the protection position after the vessel has been opened to enable the contents to be drunk. In this way the beverage can be supplied by the filler of the container ready protected and it is not necessary for the consumer to provide the protection means. In this embodiment the invention therefore provides a drink protection system having one or more of the following improvements

i) the system is inserted prior to or at the point of cap/crown/ring pull placement on the drink assembly line.
ii) the system allows for the same or very similar flow rate of beverage as is achieved from the container without the protection system and at the same time prevents pills and insects such as bees and wasps from being inserted into or entering the contents of the container
iii) optionally the system can provide for a straw to be inserted through a straw cover
iv) there can be no contamination or error issues resulting from system insertion by consumer
v) the system can be inserted into bottle mechanically, ensuring optimum and consistent positioning of the device. For example, the height difference from the top of the protection device to the mouth of a bottle may be substantially zero or close enough to prevent pills being placed on top or into the protection device system inside the neck of a bottle. Due to the precision of the process, positioning of the protection device can be the same from one container to another.

The present invention therefore provides a filled, capped beverage container provided with means that allows the contents to flow from the container and prevents the deliberate or accidental introduction of materials into the beverage after the cap has been removed.

In one embodiment the invention provides a protection device which can be inserted into the delivery system of a filled beverage container prior to or coincidental with capping the container and which is retained within the delivery system of the container upon removal of the cap. In this way the device is inserted prior to delivery of the beverage to the point of sale.

In a further embodiment the invention provides an integral closure system for a beverage container comprising a cap attached to a protection device wherein the protection device is adapted to be inserted into the delivery system of the beverage container as the cap is applied to the beverage container and the attachment is such that it is broken when the cap is removed so that the protection device remains within the delivery system of the beverage container.

The term cap is used herein to include any type of vessel closure including a screw top, a crown cap, a ring pull and the like.

In another embodiment of the invention the consumer is relieved of the responsibility for inserting the protection means by inserting the device at the point of sale of the drink to the customer.

GB2416765 describes a one way valve for protecting drinks and suggests that the valve may be fitted at the bottling stage although no information is given as to how this may be achieved. Alternatively it is stated that bar staff or the customer could fit it. The fitting by the bar staff however refers to manual fitting which is time consuming, inaccurate and may be undesirable for health reasons.

Furthermore, the design of the valve of GB241675 is complicated requiring flanges to locate the valve in the bottle, a support member and a membrane comprising flaps that are opened to allow fluid to flow out of the bottle. The valve also requires a lip to prevent the valve being pushed too far into the bottle. The flanges may be outwardly expandable or they may extend radially or helically around the valve body. Such a valve would be difficult to make, and would be delicate requiring care to fit. Another disadvantage is that the presence of the lip could facilitate removal of the device. Furthermore the valve provides a cavity in which contaminant can be placed.

In one embodiment the present invention is concerned with a system for the automated point of sale insertion of a protective device and which provides a solution to these issues. The insertion of stoppers is known however, the two fold action of opening (i.e. removing a stopper, cork or cap) and the insertion of a protection device which allows the beverage to flow from the container has not been proposed.

In a preferred embodiment the present invention therefore provides a point of sale system for bottled liquids comprising a bottle opening means associated with an automated means for the insertion of a protective device into the open neck of the bottle prior to delivery to the purchaser.

In a preferred system of the present invention the automated means for the insertion at the point of sale comprises means whereby the protective device is automatically delivered to the neck of the bottle after the bottle has been opened by the opening device together with means for the insertion of the device into the neck of the bottle.

In a further preferred system of the present invention the system is mounted at the point of sale and provides a display to prospective purchases. In particular the system may be mounted on a bar and the display is promotional material. The display may be similar to fonts that are used for dispensing liquid drinks such as beers and soft drinks.

In a further preferment of the present invention irrespective of the insertion technique the protective device is such that when fitted into the neck of the bottle it provides a surface that is substantially flush with the opening at the top of the bottle. It is preferred that the device does not have a lip to prevent it passing into the neck of the bottle and that it does not provide a cavity in the neck of the bottle.

In a further embodiment of the present invention involving point of sale insertion the protective devices are stored in a manner that they can be fed to above the neck of the bottle once the closure on the bottle has been removed. The storage may be by way of a hopper from which the devices are fed under gravity via locators to the top of the bottle. Alternatively they may be stored in cartridges and/or columns which may be stored in carrousel function to enable the store to be readily replenished by the bar.

Once the device is positioned above the neck of the opened bottle the protective device may be pushed into the neck of the bottle by mechanical means. The preferred means comprises a plate which pushes the device into the neck of the bottle. The plate is preferably larger than the surface area of the opening of the bottle so that the device is pushed so that its end is flush with the top of the bottle leaving little if any space within the neck of the bottle above the device. The plate may be provided with a resilient surface to avoid damage to the bottle.

The means for the insertion of the device may be integrated with the bottle opening means so that the opening and insertion are synchronised into an integrated continuous action of opening and insertion at the point of sale such as by means of a font positioned on a bar. The system may also be provided with a counter system to record the number of devices inserted which may be useful for health and safety purposes. The present invention therefore provides a drink device and a drink protection system wherein the device is be inserted before the beverage is delivered to the customer either during bottling or mechanically at the point of sale. The device is such that once inserted it allows for the same or very similar flow rate of beverage from the container as is achieved from the container without the protection system and at the same time it prevents pills and insects such as bees and wasps from being inserted into or entering the contents of the container

The point of sale insertion can be readily mechanised so that a protection device can be automatically selected from a pool of devices and inserted correctly and with the desired degree of force immediately after the opening of the vessel. The system can be operated electronically, pneumatically or mechanically and the insertion can be mechanical, by gas pressure or by any other means. The pool of devices can also be held in a sterile environment and fed automatically to the insertion point thus rendering the process hygienic.

The insertion at point of sale could be by means of a font device preferably positioned on the bar or near the area where the vessel particularly a bottle is un-capped. The font can also comprise means for advertising to the public both relating to the component and other drinks brands or other advertisements if desired. Such medians can be used like poster style, holographic projection, moving images etc.

When a font is employed it can be used to build awareness surrounding the safety component and drinks brands promoting safer drinking. The font preferably contains means to store multiple quantities of components, means to select a single component from storage to point of insertion which is positioned correctly. The font also included the means to insert the component with the correct force into the bottle neck at the correct position time after time. Means are also required within the font to allow positioning of the bottle to receive a component. The means to drive the insertion or activate the process can be gas cylinder, electrical or mechanical and the like but always activated by a skilled and responsible person preferably behind the bar, when used in a bar, such as the bar person. It is further preferred that the font's insertion point is facing behind the bar and the advertising is projected in the opposite direction towards the consumer. Optionally, means can be provided to clean the inserter or driver head. In a preferred system for point of sale insertion the font is preferably positioned on a bar. The font will contain a light which illuminates the front facing aspect. Provision for advertising on front facing aspect can be made, a message and a logo with aesthetic shape to replicate its function-shape of for example a large beverage bottle with closure removed and the protector component inserted in top. In a preferred embodiment a magnetic strip can be provided around neck of bottle to change the advertising message.

The preferred font will house a number of protective closures in a replaceable canister comprising columns which operate like a carousel style mechanism. Typically 20 to 40 devices may be provided per column. The columns being around the inside perimeter of the circumference of the bottle. The font will also have access for more devices for example the devices may be supplied in cartridges pre assembled for barpersons to plug into the font.

The fonts operational interface will face towards the bar side so that the bar person is the operator.

The font is designed so that it is able to remove the crown closure from a bottle usually a glass bottle, and then insert one of the devices the correct way into the bottle preferably by mechanical means repeatedly. For example, a lever may be manually lifted when a crowned bottle is positioned in the font system, as the lever lifts, optionally, the crown can be removed and then as the lever is pulled down, a component which has been positioned by the motion of the lever can be inserted into the neck of the bottle by a plate and locators. The face of the plate has a wider diameter than the device and will prevent the lever from being pushed down further when the plate makes contact with the top surface of the neck of the bottle. Therefore the device will be positioned in the same position time after time.

The font to also cater for component insertion into plastic bottles. The font may also include a counter allowing the till total to be verified against the number of devices used. In the embodiment of the invention involving insertion on line during the bottle filling process it is possible to introduce the protection device at any other stage of the drink assembly process. However, due to the large investment costs required for serious changes on the assembly line of producing ready to drink beverages, we prefer to provide the device when the cap is positioned onto the bottle. This way the additional number of manufacture actions and tools required are limited.

In on line insertion it is preferred to provide the protection device through use of the pressures employed in the existing method of applying the cap. In a preferred embodiment the protection device is integral to the cap or crown or it is positioned in such a way that the cap or crown or a part of the cap or crown machinery holds the device in the correct position for insertion. When the cap or crown is released or the seal is broken to access the content of the bottle, the protection device remains in the desired position. The protection device is preferably shaped according to the dimensions of the delivery system of the beverage container so that the forces being exerted by a capping machine, wedge the device securely into the delivery system and makes it highly improbable for the device to be dislodged from the bottle.

The present invention therefore provides a much greater degree of security than with systems which require hand insertion of a protection device by the ultimate consumer.

Any appropriate material can be used to make the protection device, such as flexible membranes, flexible meshed fabrics, various plastics etc. Due to the critical cost of the component we prefer to use a single material to make a single component or co mold (two shot) component with a more flexible material such as a thermoelastomer. Any food grade compliant material can be used a polyethylene terephthalate, polypropylene or higher low density polyethylene being preferred since forms of these materials can be provide both the rigidity and flexibility that is required. The material must be sterilisable and for on line insertion it must be able to withstand conditions that prevail in the particular beverage filling line. The material can also be selected so that it does not have an adverse effect during recycling of the container.

The protection device must serve the dual function of allowing the contents of the vessel to flow out from the vessel without significantly interrupting normal flow conditions and also provide difficult to remove protection. The optimum shape and form of the protection device will depend upon the shape of the delivery system of the vessel. However we prefer that the device provides an open mesh surface which permits the contents to flow from the vessel. We also prefer that the device has a degree of flexibility and is dimensioned so that it requires some force for insertion into the delivery system of the vessel so that it is a tight fit making illicit removal from the delivery system difficult. A preferred device for use with a necked bottle can have a short cylindrical body provided with the mesh at one end, usually the end to be nearest to the consumer, and provided with external longitudinal ribs which lock firmly against the inner surface of the delivery system upon insertion. In another optional embodiment the device can be coloured to indicate the particular type of drink contained in the vessel.

By way of example, the protection system can be inserted into a ready to drink glass bottle. The internal diameter of the crown cap of a bottle without interfering with the seal to bottle is about 18.5 mm or less. A glass bottle internal neck diameter is typically in the range of 15 to 25 mm but typically about 18 mm. As shown in FIG. 2, we prefer that the top face of the protection systems dimension (A) fits within 18.5 mm (A) but can extend down providing distance (B) between the crown and widest point of the system (C). We also prefer the system to have a wider neck than 18 mm at this point (C′) to ensure a firm fit and for the shape to taper from the base (D) to the point (C). The length from (D) to (C) is preferably less than the length of the neck of the bottle but long enough to ensure positioning is maintained as well as ensuring a secure fit within the neck of the bottle.

For on line insertion provision can be made for temporary attachment of the protection device to the cap or crown. This will aid in the insertion process on the assembly line.

Caps or crowns are sometimes provided with inner plastic layers and in the on line aspect of this invention the plastic layer may be provided with a male part for temporary attachment to a female part provided on the protection device or vice versa. Alternatively the protection device can be integrally moulded with the inner plastic layer. FIG. 2 also illustrates an internal ribbing design to provide support. This design is particularly beneficial since, in addition to the outside ribbing, it does not require a side action on the production tool to make each component. This saves both investment costs and component cycle time during production. Internal ribs can be provided for increased strength although these can be minimised to reduce the amount of material employed.

The system illustrated is particularly useful for insertion into bottles which may be of plastic or glass.

A device as described may be used for on line insertion or point of sale insertion. It has the benefits that

i) It provides a mesh top for consumption direct from the container
ii) It can employ longitudinal ribs for location of the device within the neck of the bottle which facilitates the mechanical insertion of the device and provides passageways between the ribs for the passage of liquid and/air
iii) It can provide a cap for the orifice for the drinking straw to provide protection for the consumer against contamination before insertion of the straw and is an aspect of the present invention.

The present invention therefore provides a device for insertion into drinking vessels in order to provide security against contamination of the contents of the vessel. The device comprises an insert having a mesh surface to allow passage of liquid and preferably a plurality of protrusions to secure the insert in the vessel wherein the pattern of the protrusions, when present, provides passageways for the flow of liquid out of the vessel and/or the flow of air into the container. The invention also provides a process for the automatic/mechanical insertion of the device prior to delivery of the beverage to the consumer.

The mesh surface is generally the uppermost surface of the device and in position is at or close to the exit from the vessel.

In a preferred embodiment protrusions are present and are ribs which extend longitudally down the exterior of the device and are sufficiently small and sufficiently close to prevent the insertion of contaminants into liquid contained within the vessel. The protrusions can create small channels between the core of the device and the interior surface of the neck of a bottle which allow flow of liquid. If the exterior surface is flat and a tight flush fit with the interior delivery system of the vessel it may be necessary to structure the interior of the device to aid liquid flow out of the vessel and air flow in. The component can have non tapered longitudinal ribs to fit the bottle. It may be desired to have straight ribs allowing for more contact area. These ribs may be very thin to act as sacrificial parts creating a folding and greater force.

In a further preferred embodiment the device is provided with a capped orifice in the meshed surface for the insertion of a drinking straw. The act of insertion of the straw should break the cap so that the consumer can see that there has been no tampering with the vessel prior to insertion of the straw.

The use of the device of this invention therefore has the following benefits

i) It can automatically be inserted into the neck of the bottle thus removing the problem of missed operations and also being hygienic
ii) the system allows for the same or very similar flow rate of beverage as is achieved from the container without the protection device and at the same time prevents pills and insects such as bees and wasps from being inserted into or entering the contents of the container
iii) to function as a drink safe device the component is not reliant on use of a straw
iv) optionally the system can provide for a straw to be inserted through a straw cover which can alert the drinker if the cover is broken by other means.

In one form, the device can come with a lip which prevents forces from pushing the component into the bottle which may also aid the positioning of the component at the point of insertion. However, in some situations this may not be beneficial since a component that is dislodged from within the container will give a better indication of whether the drink has been tampered with than a device which can be removed more easily with a lip then replaced in to the same position without any physical differences in appearance. It is therefore preferred in our invention not have a lip or top surface which protrudes the external sidewalls of the device to sit on the outer surface of the bottle neck providing easy leverage to remove said device.

It is further preferred that the positioning of the system upon insertion is that the top of the device is flush with the top of the bottle and not protruding therefrom. Furthermore it is preferred that it is not totally inside the neck of the bottle to the extent that space is created for illicit substances to sit.

It is further preferred that the system does not ‘hug’ or have any interaction with the external walls of the bottle or beverage container or with the upper lip of the bottle opening.

In a further embodiment the mesh section of the protection device of the present invention can be designed so that it is difficult to pour the contents of the vessel into a secondary container. In this way the likelihood of contamination is reduced. The device can also limit the flow if the bottle is knocked over for example. In this way it can become an anti spill mechanism which is particularly useful for example for children's drinks.

It is preferred that the protrusions are ribs and are vertical ribs since a device with vertical ribs is easier to manufacture by injection moulding with a reduced cycle time per component as an open and shut tool can be used as opposed to a side action. Side action tools are required if horizontal ribs are used such as those used in GB 2416249 and GB 2416765. As an alternative to ribs, the protrusions can be ridges formed down the external side wall of the component.

The invention therefore allows a device to be provided as part of the vessel filling operation. Whilst this is useful there is also a need for the provision of the device at the point of sale such as in bars, public houses, restaurants, outdoor entertainment events and the like. The present invention can therefore provide a system wherein the device can be automatically inserted at the point of sale of the beverage by the vendor. For example it could, on request or automatically be inserted by a barman at the time of opening the vessel ready for sale.

Accordingly in a further embodiment the present invention provides a point of sale beverage delivery system wherein a beverage vessel is opened for sale and a contamination protection device is inserted into the vessel and the protected vessel then provided to the consumer.

The device of the present invention is particularly useful in such a beverage delivery systems and this aspect of the invention provides the following benefits

a) there can be no contamination or error issues resulting from device insertion by the consumer
b) the device can be inserted into a vessel such as a bottle automatically and/or mechanically, ensuring optimum and consistent positioning of the device. For example, the height difference from the top of the protection device to the mouth of a bottle may be substantially zero or close enough to prevent pills being placed on top or into the protection device system inside the neck of a bottle.
c) the delivery system ensures that although the device could be dislodged it will be difficult to do so and it will be obvious to the drinker that it has been dislodged which provides a further safety alert as opposed to a component being removed and replaced without the drinker's knowledge.

The invention is applicable to most if not all types of sealed beverage container, bottles, cans, barrels, paper containers and the like. Although it is particularly useful with bottled drinks the concept can also be applied to liquid foodstuffs such as milk, sauces and the like. The nature of the delivery system of a container will vary according to the nature of the container. In the preferred embodiment where the container is a bottle the delivery system comprises the neck of the bottle.

The present invention is illustrated but in no way limited by reference to the accompanying Figures in which

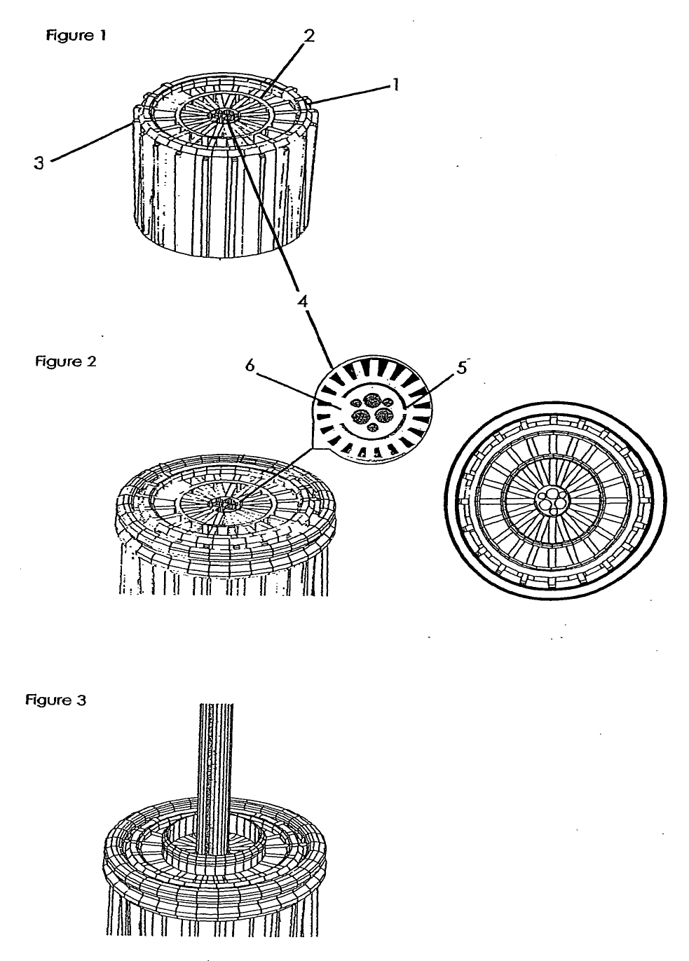

FIG. 1 is a view of a protection device suitable for insertion according to the present invention.

FIG. 2 shows a bottle with a device of FIG. 1 inserted in the neck thereof.

FIG. 3 shows how a straw can be inserted into the device.

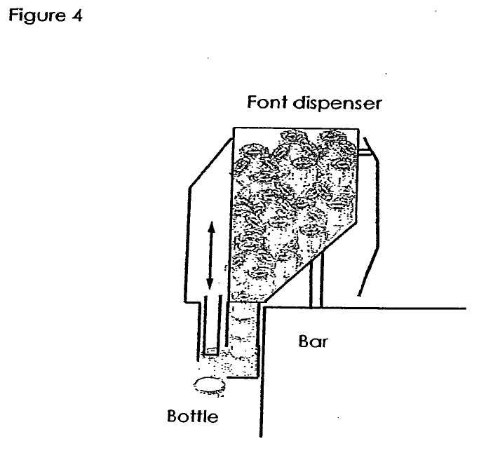

FIG. 4 shows a drink dispenser container including a font for insertion of the device.

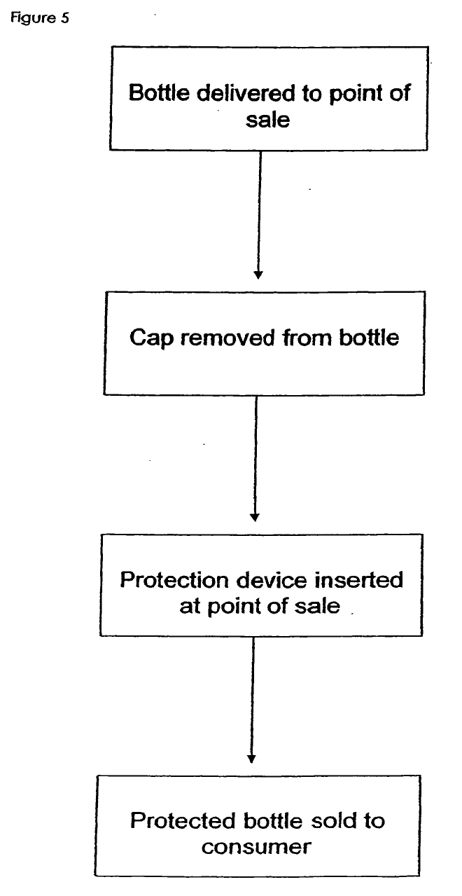

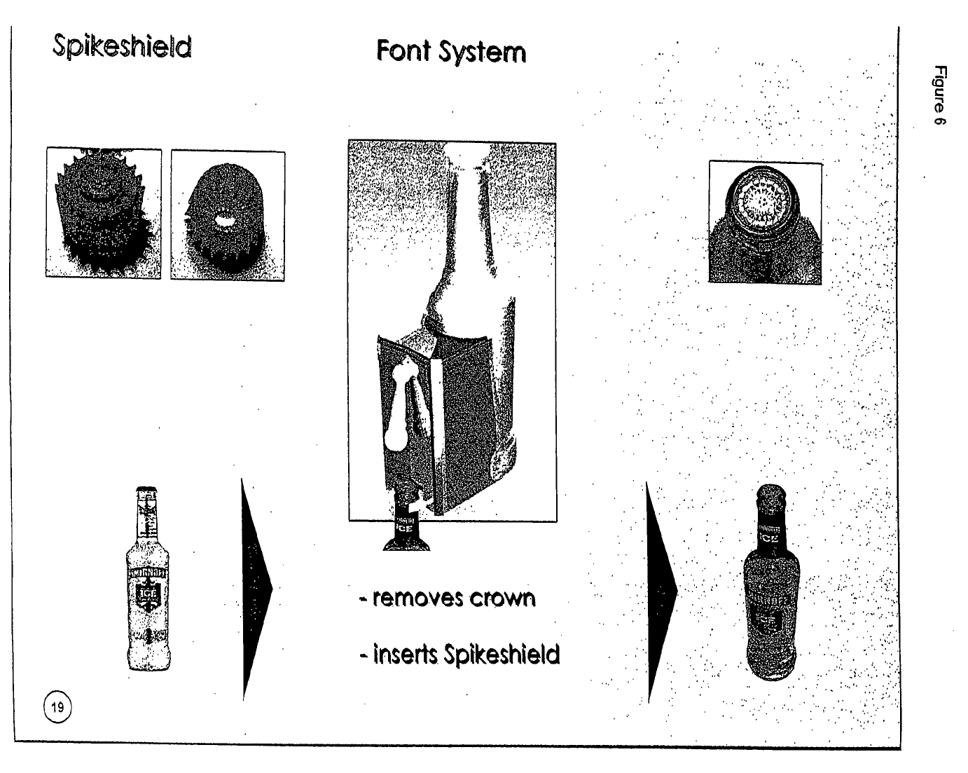

FIG. 5 is a flow chart illustrating the point of sale embodiment of the invention.

FIG. 6 shows a font system and how it can remove a bottle cap and insert the protective device.

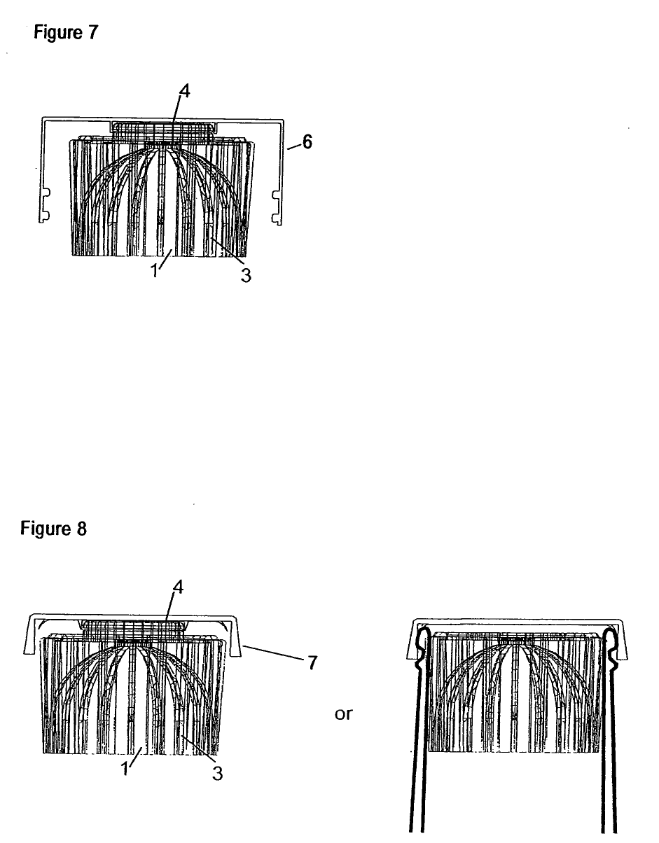

FIG. 7 shows a device that can be inserted on line with the protection device attached to the bottle closure.

FIG. 8 shows the device attached to an alternate closure.

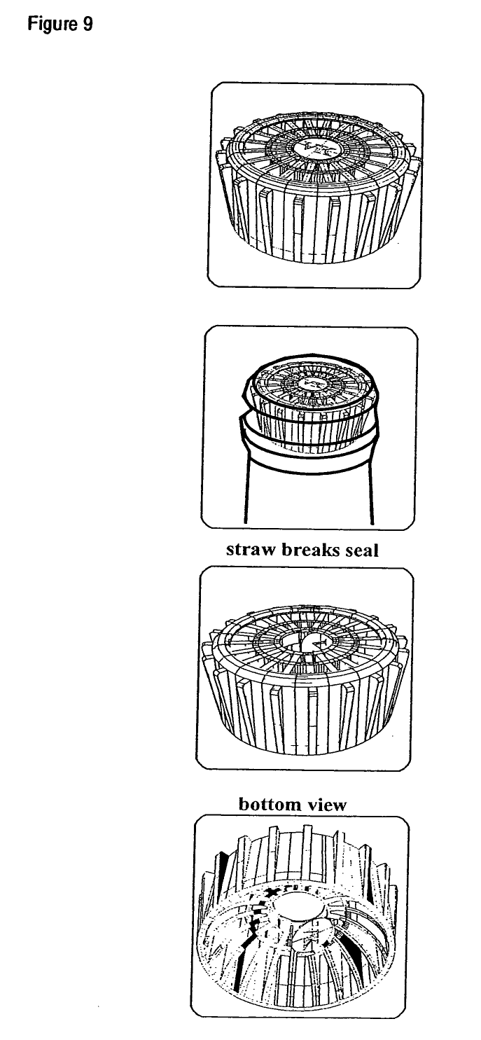

FIG. 9 shows how the underside of a protection device may be provided with means to prevent the removal of a drinking straw once it has been inserted.

FIG. 1 shows a protection device having a cylindrical body (1) provided with a mesh structure (2) at one end to provide protection against contamination and to allow outflow of the contents of a bottle to which it is fitted. The cylindrical body is provided with external longitudinal ribs (3) which are of a size that they will secure the device inside the neck of a bottle. FIG. 1 also shows the central section (4) through which a drinking straw can be pushed attached to the mesh structure by one thin breakable unit (5) and a more robust limb (6).

The protection system shown in FIG. 1 can be inserted into a ready to drink glass bottle as shown in FIG. 2.

The tapered parts (3) of the system such as those illustrated maybe sacrificial since they may be compressed, change shape or distort to ensure the fit is firm. These parts may also be made from a co-moulded material such as a thermoelastomer; alternatively they may be of the same material as the remaining system. Where a rib system is provided it may also create channels between the exterior of the cylindrical portion of the protection device and the inner surface of the delivery system to allow flow of the beverage along the channels as well as through the mesh.

FIG. 3 shows the central section of the device shown in FIG. 1 broken at limit (5) for the passage of a straw.

FIG. 4 shows a font mounted on a bar for dispensing the protective device into a bottle.

FIG. 5 is a flow chart of the point of sale system of the present invention.

FIG. 6 shows a further font system and its operation.

FIGS. 7 and 8 show a device attached to a closure which can be used for in line insertion.

FIG. 9 shows how a cap can be provided that is broken by the insertion of a straw and the underside of the device can be provided with means to retain the straw once it has been inserted.

The system illustrated is particularly useful for insertion into bottles which may be of plastic or glass.

Although research shows that the most readily accessible illicit substances which are the easiest way to carry and introduce to a drink are in the forms of pills, it is possible to obtain substances in the form of liquids and powders. Whilst the system of the present invention will deter and probably prevent introduction of pills, the introduction of liquids and powders cannot be guaranteed. However we have found that an attempt to introduce a powder leaves traces around the neck of the bottle and around the protection device. Furthermore we have found that it takes longer to introduce a powder or liquid than without the protection device. It is also very difficult to introduce a liquid into the drink without leaving part of it on the device, these trace quantities might provide a sufficient concentration to alert the drinker. The protection device could also be made from material that reacts to certain known contaminants to provide a warning to the consumer.

The protection device may be provided with means to allow the introduction of a drinking straw through the device and into the contents of the drinking vessel. In a preferred embodiment the central part or area on the top face of the protection device is detachable preferably through downward force such as can be applied by pushing the end of a drinking straw against the central part or area. It is preferred however that the central part or area is not totally detached from the protection device but folds away to allow passage of the drinking straw. In this way any problems associated with the central part falling into the bulk of the contents of the drinking vessel can be avoided. FIG. 3 illustrates how a straw can be inserted. By pushing the central part of the top of the protection device, the straw can be inserted. Detachment can be achieved by limiting the attachment of the central part to the surrounding plastic to a number of points rather like perforated paper. Some sections of the perforations can be thicker preventing the inside area or circular disc from being completely detached but allowing for insertion of the straw.

As part of the point of sale system, optionally a straw perhaps a branded straw can be provided with means for opening the straw cover with a diameter that is a little less than the diameter of the straw hole providing a snug fit and means once located into an appropriate position to prevent or deter removal of the straw. Such means can include a fish hook barb for example as part of the form of the straw.

The system of the present invention is also useful in preventing insects such as wasps and bees from entering a beverage. Whilst the sugar sweetness of the drink attracts the insects, it is possible to receive nasty stings internally or to swallow insects without such a system in place. The shape of a protection device with the straw cover included acts as a guard. When a straw is the preferred method of withdrawing the content of the bottle, the straw penetrates the straw cover creating a straw hole; the straw will replace the protection provided by the straw cover section and therefore maintains prevention of insects such as wasps and bees getting inside the neck of the bottle. If a drink is left unattended, for example when a child is playing in the park and wasps are trying to get in the bottle, when the drink is required again it will be obvious to see the wasp(s) on top of the bottle as opposed to inside and consequently the drinker or drinker's guardian/parent will be alerted.

As well as preventing contamination the use of the protection device of the present invention can provide evidence of tampering or attempting to tamper with drinks. For example, if the straw cover has been broken or if the device is not in the same position prior to drinking, it is likely that the drink has been tampered with and the consumer will be alerted to this. Any attempt to push the device down the neck of a bottle with great force, will be known to the consumer since the position of the device will have been obviously altered. In some embodiments of the device, it maybe preferred to have the top face comprising the grid shape of the device to have a very thin wall thickness ensuring that if it is tampered with, the grid becomes broken or disfigured also alerting the potential drinker.

In a further embodiment the protection device of the present invention can be designed so that it is difficult to pour the contents of the vessel into a secondary container. In this way the likelihood of contamination is reduced.

The invention provides a protection device and means for its insertion prior to delivery of the beverage to the customer industry on line insertion and point of sale automatic or mechanical insertion of the protection device. The point of sale may be permanent such as in a pub, wine bar, hotels, restaurants or may be temporary facilities such as festivals, sporting events and home festivities. It is applicable whenever bottle drinks are served to consumers. The system can also be provided to individuals for use at personal functions where drinks are available free of charge

The device of the present invention has the additional benefit that it can limit or prevent spillage if a bottle provided with the device is tipped over. It has been found that the liquid's membrane within the bottle enhances the preventative qualities of our component. For example when testing with transparent liquid and dyed liquid if the bottle is turned upside down and returned to its upright position the liquid creates an additional barrier within the design enhancing the performance of the component against the introduction of contaminants such as powders and dyed liquids. We find the contaminants either sit on the top and are obvious to the drinker or in the worst case enter the mouth but are in such strong concentration, the drinker is alerted and acts accordingly. The non spill properties of the invention are also enhanced once the seal is created.

The rate of flow of liquid from a bottle containing a device can be maximised when the mouth does not create a seal around the bottle neck and a slight drawing action is used. This creates a safe flow and consistent flow which can be more enjoyable than a swig or glug. The flow can also be controlled so that it does not reach the back of the throat forcing the drinker to gag and does not encourage binge drinking.

When the system of the present invention is put into practice in addition to provision of the protection device it provides the opportunity for the provision of a font for the delivery and insertion of the device which also provides an advertising or promotional opportunity. Where the system is to be used for advertising it may employ more than one font. For example one font unit may provide static advertising and information and a second font could provide a multimedia unit with, for example, TFT advertising.

1. A device for insertion into a drinking vessel in order to provide security against contamination of the contents of the vessel comprising an insert having a mesh surface to allow passage of liquid.

2. A device according to claim 1 provided with a core and a plurality of protrusions to secure the insert in the vessel wherein the device is provided with a pattern of the protrusions on its outer surface which provide passageways between the core and the interior surface of the drinking vessel for the flow of liquid out of the vessel and/or the flow or air into the container.

3. A device according to claim 1 in which the mesh surface is the uppermost surface of the device and in position is at or close to the exit of the vessel.

4. A device according to claim 2 in which the protrusions are ribs which extend longitudally down the exterior of the device.

5. A device according to claim 4 in which the ribs are sufficiently small and sufficiently close to prevent the insertion of contaminants into liquid contained within the vessel.

6. A device according to claim 2 in which the protrusions create small channels between the core of the device and the interior surface of the neck of a bottle which allow flow of liquid.

7. A device according to claim 1 provided with a capped orifice in the meshed surface for the insertion of a drinking straw.

8. A bottle containing a device according to claim 1.

9. A bottle according to claim 7 wherein the positioning of the device upon insertion is such that the top of the device is flush with the top of the bottle and not protruding there from.

10. A bottle according to claim 8 in which the device is not totally inside the neck of the bottle to the extent that space is created for illicit substances to sit.

11. A point of sale beverage delivery system wherein a beverage vessel is opened for sale, a contamination protection device is inserted into the vessel and the protected vessel then provided to the consumer.

12. (canceled)

13. A point of sale system according to claim 11 in which the insertion at point of sale is by means of a font.

14. A point of sale system according to claim 11 in which the insertion is automatic.

15. A point of sale system according to claim 14 in which the insertion is mechanical, pneumatic, or electrically driven.

16-20. (canceled)

21. A point of sale system according to claim 14 in which the font also comprises one or more of means for advertising to the public, means to insert the component with the correct force into the bottle neck at the correct position, and means to store multiple quantities of devices, means to select a single device from storage and move it to a point of insertion.

22-25. (canceled)

26. An integral closure system for a beverage container comprising a cap attached to a protection device wherein the protection device is adapted to be inserted into the delivery system of the beverage container as the cap is applied to the beverage container and the attachment is such that it is broken when the cap is removed so that the protection device remains within the delivery system of the beverage container.

27. An integral closure according to claim 26 in which the cap or crown is provided with an inner plastic layer and in the invention the plastic layer may be provided with a male part for temporary attachment to a female part provided on the protection device or vice versa.

28. (canceled)

29. A process for the production of a filled, capped beverage container provided with a protection device according to claim 1, wherein the device is provided in the bottling assembly line when the cap is positioned onto the bottle.

30. A process according to claim 29 wherein the protection device is provided to the beverage container through use of the pressures employed in the method of applying the cap.

31. A process according to claim 30 in which the protection device is integral to the cap or crown or it is positioned in such a way that the cap or crown or a part of the cap or crown machinery holds the device in the correct position for insertion.

32. (canceled)
